(19) United States
(12) Patent Application Publication
(10) Pub. No.: US 2022/0060485 A1
(43) Pub. Date: Feb. 24, 2022

(54) THREAT FORECASTING

(71) Applicant: BRITISH TELECOMMUNICATIONS PUBLIC LIMITED COMPANY, London (GB)

(72) Inventors: Xiao-Si WANG, London (GB); Zhan CUI, London (GB)

(21) Appl. No.: 17/417,571

(22) PCT Filed: Dec. 11, 2019
(86) PCT No.: PCT/EP2019/084693

§ 371 Date: Jun. 23, 2021

(30) Foreign Application Priority Data
Dec. 27, 2018 (EP) 18248033.5

(51) Int. Cl. H04L 29/06

(52) U.S. Cl. CPC H04L 63/145; H04L 63/1425; H04L 63/1433

(57) ABSTRACT

A computer implemented method of protecting a network of computer systems, the method comprising: receiving security data for the network, the security data comprising threat event data for threat events detected within the network over a period of time; extracting, from the received security data, one or more features indicative of a computer system being compromised by a particular threat; generating a forecast of a number of computer systems in the network compromised by the particular threat at a future point in time based on the one or more features; determining whether action should be taken to mitigate the particular threat based on the forecast; and in response to determining that action should be taken, causing one or more predetermined actions to be taken to mitigate the particular threat.

The present invention relates to the detection of threats in computer systems. In particular, it relates to forecasting the number of computer systems that will be affected by particular threats.

Threats to computer systems come from a variety of sources, including, for example, the actions of authorised users, unauthorised attackers (commonly referred to as hackers) and malicious software (or ‘malware’). The types of threats can be broken down further within each of these categories based on the manner in which the threat operates or on particular vulnerabilities that are exploited. As an example, malware may be broken down (or categorised) into Trojan Horses, Viruses, Worms, Ransomware and so on (and may be sub-categorised further). A group of threats having the same characteristics (such as those having a similar mode of operation or exploiting the same vulnerabilities) may be grouped together as a threat family.

Endpoint security software is typically used to detect threats on a per-system basis. For example, organisations implement standard malware detection technology installed in or for each system, appliance or resource connected to an intranet. This technology can detect when a computer system is threatened by a particular threat and can take steps to prevent the computer from being compromised. Similarly, the technology may also detect when a computer system has been compromised by a particular threat that could not be prevented. By gathering such information, administrators of the computer systems on the computer network can react to threats as they occur. For example, any computer systems that have been detected as being compromised can be assessed to determine any impact, and action can be taken to remove or reduce any ongoing risk posed by the compromising threat (such as the risk of losing the confidentiality of any data processed by those computer systems). These actions can also help to reduce the risk of other computer systems in the network being compromised, since the compromise of one computer system on a computer network can often serve as a springboard from which further threats to other computer systems on the network may be launched. For example, malware may automatically seek to compromise (or infect) other computer systems that have a vulnerability which is used by the malware. Similarly, compromised computer systems may be used to launch attacks, such as denial of service (DoS) attacks, on other computer systems in the network (or indeed outside of the network).

However, this approach is necessarily reactive and it can be hard to prioritise which threats should be dealt with as a priority, particularly when simultaneously faced with a large number of threats currently being detected within a network. Similarly, it can be hard to know whether sufficient action has been taken to sufficiently mitigate a particular threat within the network (that is to say, to reduce the risk from the particular threat down to an acceptable level given the resources available for dealing with threats to the computer network).

Accordingly, it would be beneficial to mitigate these disadvantages.

The present invention accordingly provides, in a first aspect, a computer implemented method of protecting a network of computer systems, the method comprising: receiving security data for the network, the security data comprising threat event data for threat events detected within the network over a period of time; extracting, from the received security data, one or more features indicative of a computer system being compromised by a particular threat; generating a forecast of a number of computer systems in the network compromised by the particular threat at a future point in time based on the one or more features; determining whether action should be taken to mitigate the particular threat based on the forecast; and in response to determining that action should be taken, causing one or more predetermined actions to be taken to mitigate the particular threat.

Through the extraction of features indicative of a computer system being compromised by a particular threat and the use of those features to generate a forecast (or prediction) of the number of computer systems in the computer network that will be compromised by the particular threat at a future point in time, the present invention enables the prioritisation of actions to mitigate threats to be dealt with in a more efficient manner. Specifically, the invention will take action to mitigate threats based on a forecast of the number of computer systems those threats are likely to compromise, meaning that resources are more focussed on dealing with those threats that are most likely to have the largest impact on the computer network. This in turn can improve the effectiveness with which those threats are mitigated, helping to improve the security of the network.

Preferably, the one or more features to be extracted are discovered through feature learning.

Preferably, one or more of the extracted features are filtered to produce one or more filtered features and the forecast is generated based, at least partly, on the one or more filtered features.

The present invention accordingly provides, in a second aspect, a computer system comprising a processor and a memory storing computer program code for performing the method set out above.

The present invention accordingly provides, in a third aspect, a computer program which, when executed by one or more processors, is arranged to carry out the method set out above.

Embodiments of the present invention will now be described by way of example only, with reference to the accompanying drawings, in which:

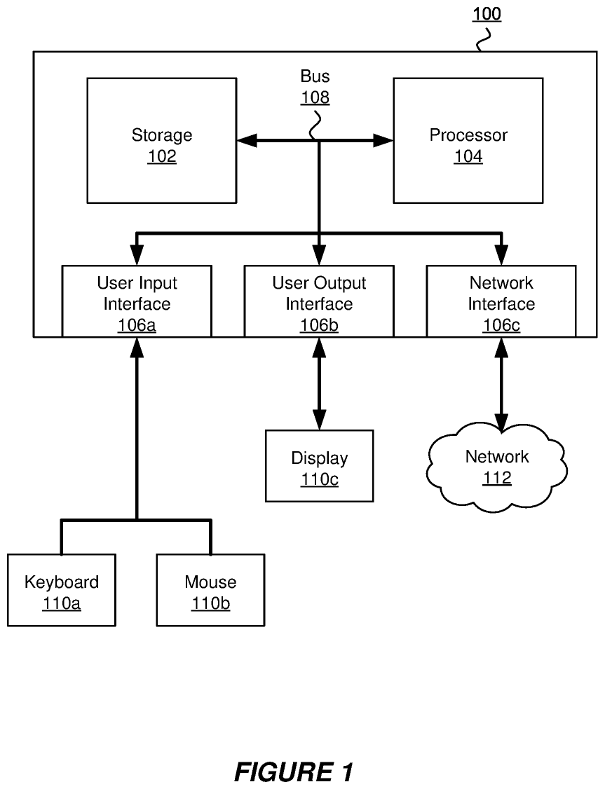

FIG. 1 is a block diagram of a computer system 100 suitable for the operation of embodiments of the present invention.

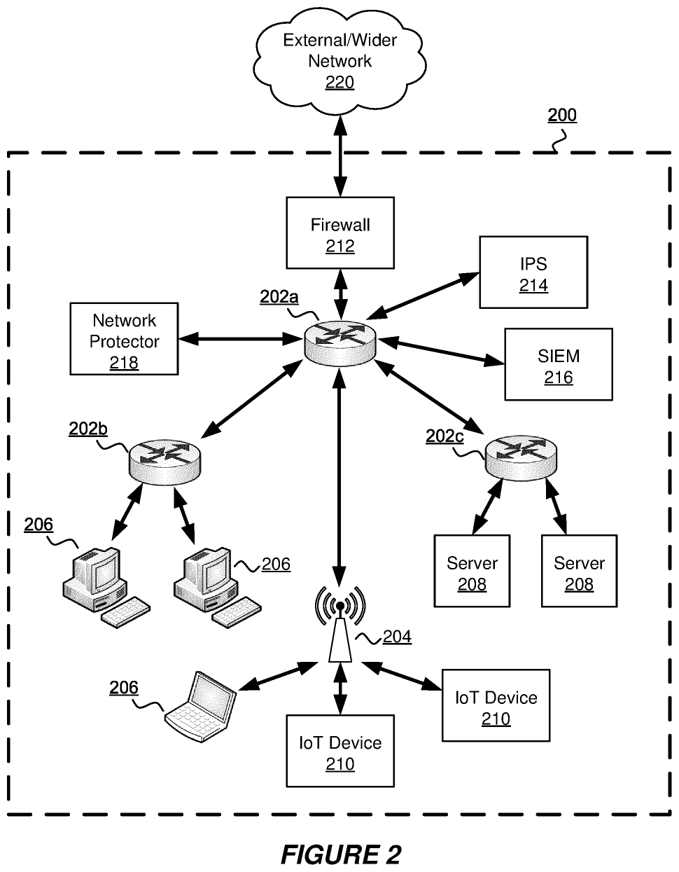

FIG. 2 is a block diagram of a computer network 200 which embodiments of the present invention may act to protect.

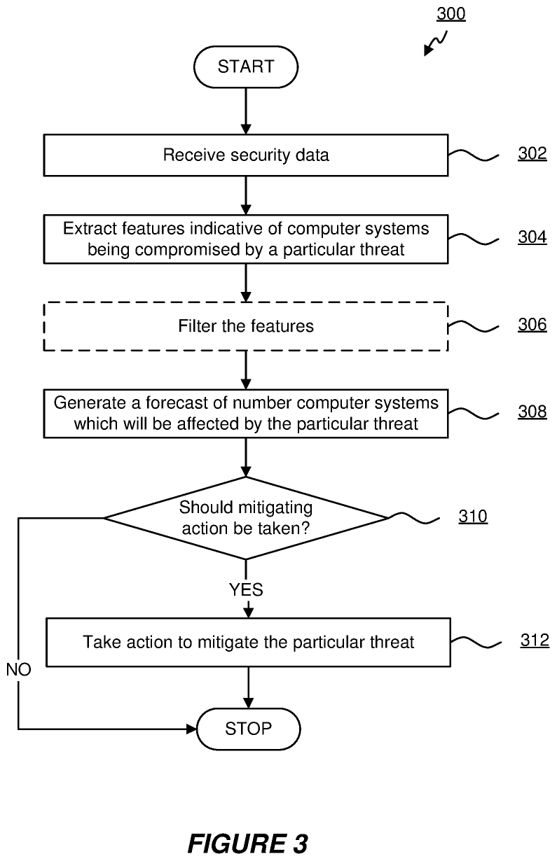

FIG. 3 is a flowchart of a method 300 of protecting a computer network in accordance with embodiments of the present invention.

FIG. 1 is a block diagram of a computer system 100 suitable for the operation of embodiments of the present invention. The system 100 comprises: a storage 102, a processor 104 and one or more input/output (I/O) interfaces 106, which are all communicatively linked over one or more communication buses 108.

The storage (or storage medium or memory) 102 can be any volatile read/write storage device such as a random access memory (RAM) or a non-volatile storage device such as a hard disk drive, magnetic disc, optical disc, ROM and so on. The storage 102 can be formed as a hierarchy of a plurality of different storage devices, including both volatile and non-volatile storage devices, with the different storage devices in the hierarchy providing differing capacities and response times, as is well known in the art.

The processor 104 may be any processing unit, such as a central processing unit (CPU), which is suitable for executing one or more computer programs (or software or instructions or code). These computer programs may be stored in the storage 102. During operation of the system, the computer programs may be provided from the storage 102 to the processor 104 via the one or more buses 108 for execution. One or more of the stored computer programs are computer programs which, when executed by the processor 104, cause the processor 104 to carry out a method according to an embodiment of the invention (and accordingly configure the system 100 to be a system 100 according to an embodiment of the invention).

The one or more input/output (I/O) interfaces 106 provide interfaces to devices 110 for the input or output of data, or for both the input and output of data. The one or more interfaces 106 may include one or more user input interfaces 106a for connecting to devices which can receive input from a user of the system 100, such as a keyboard or mouse. The one or more interfaces 106 may include one or more user output interfaces 106b which can provide an output to the user of the system 100, such as a display or monitor. In some cases a single device, such as a touch screen display, may be connected to both an input interface 106a and an output interface 106b and used both to receive input from the user of the system 100 and provide output to the user of the system 100. The one or more interfaces 106 may include one or more network interfaces 106c which enable the computer system to communicate with other computer systems via one or more networks 112.

Other interfaces (not shown) may also be present in the computer system and there are many other types of devices (not shown) which may be used with system 100, such as various sensors and actuators.

It will be appreciated that the architecture of the system 100 illustrated in FIG. 1 and described above is merely exemplary and that other computer systems 100 with different architectures (such as those having fewer components, additional components and/or alternative components to those shown in FIG. 1) may be used in embodiments of the invention. As examples, the computer system 100 could comprise one or more of: a personal computer; a laptop; a tablet; a mobile telephone (or smartphone); a television set (or set top box); a games console; an Internet of Things (IoT) device; a server; a network appliance, such as a router, firewall, intrusion detection system (IDS) or intrusion prevention system (IPS); or indeed any other computing device. The devices 110 that interface with the computer system 100 may vary considerably depending on the nature of the computer system 100 and may include devices not explicitly mentioned above, as would be apparent to the skilled person. For example, an Internet of Things (IoT) device might have a network interface 106c, but no user input interface 106a or user output interface 106b (although, of course, such interfaces may be present in some IoT devices) and might additionally have an interface 106 to one or more sensor and/or actuator devices 110.

FIG. 2 is a block diagram of a computer network 200 which embodiments of the present invention may act to protect. The network 200 comprises a plurality of computer systems 100 including routers 202a, 202b and 202c, wireless access point 204, end-user computing devices 206, servers 208, Internet of Things (IoT) devices 210, as well as various network appliances, such as a firewall 212, Intrusion Prevention System (IPS) 214 and Security Information and Event Management (SIEM) system 216. It will again be appreciated that the computer network 200 that is illustrated is merely exemplary and embodiments of the invention may operate within networks having a different structure, including those having fewer, more or different components to those shown in FIG. 2.

The routers 202a, 202b and 202c may manage the flow of traffic within the network 200. For example, end-user computing devices 206 may be connected to router 202b, whilst servers 208 may be connected to another router 202c. The routers may be arranged to pass traffic between the end-user computing devices 206 and the servers 208 by passing the traffic between the routers 202a, 202b and 202c, as will be well understood. Some of the computer systems may be connected to the network 200 wirelessly, such as through the wireless access point 204. Although not shown in FIG. 2, in other embodiments, the network 200 may comprise a cellular network, with mobile devices connecting wirelessly through the cellular network. For example, many IoT Devices 210 are arranged to connect to a network wirelessly so as to allow convenient installation (although, of course, other IoT Devices may use a wired connected to the network 200 instead).

The network 200 may be connected to an external network 220 (or, indeed, multiple external networks) such that computer systems within the network 200 can communicate with other computer systems in the external network 220. Conceptually, the network 200 may be considered to be a portion (or part) of a larger network, in which case the wider network 220 may be considered to be an external network (even if it is under the same administrative control). As shown in the exemplary network illustrated in FIG. 2, the only connection between the external/wider network 220 and the network 200 is via the firewall 212. The firewall 212 may be configured to manage the traffic flowing between the other computer systems on the network 200, for example based on firewall rules, such that some types of network traffic are allowed to pass from the network 200 to the external/wider network 220 (or from the external/wider network 220 to the network 200) whilst other types of network traffic may be blocked and prevented from passing between the network 200 and the external/wider network 220. The firewall 212 may also be configured to manage the network traffic flowing between different computer systems within the network 200. Alternatively, additional firewall devices may be included within the network 200 for this purpose.

Although the exemplary network illustrated in FIG. 2 includes a firewall 212 between the network 200 and the external/wider network 220, it will be appreciated that this is not necessary. For example, in some embodiments, the network 200 may be directly connected to the external/wider network 220 without using a firewall 212. In other embodiments, the network 200 can include multiple connections to external networks, with each such connection entering the network 200 via a different computer system. In yet other embodiments, the network 200 might be a standalone network and may not be directly connected to an external/wider network 220. Of course, it will be appreciated that even standalone networks may be subject to the threats discussed herein. For example, malware can be introduced to the network through removable (or portable) storage media, such as USB storage devices or Optical discs such as CDs or DVDs. Similarly, authorised users may still present a threat, as indeed can unauthorised users (who might, for example, seek to access the network 200 via a wireless connection to the wireless access point 204).

The Intrusion Detection System (IDS) 214 is used to identify threats within the network. As will be appreciated, an Intrusion Prevention System (IPS), which also attempts to respond to mitigate the threats that are identified, may be used instead. One type of IDS (or IPS) that may be used is a Network-based IDS (or NIDS) which runs on a separate computer system within the network 200, such as the IPS 214 illustrated in FIG. 2. A NIDS monitors traffic within the network 200 and seeks to identify threats within the network from this traffic. This may be achieved, for example, through the use of anomaly-based detection to identify deviations from a model of “good” network traffic (which is typically learnt using machine-learning). It may also attempt to identify malware within the network traffic. This may be achieved, for example, through the use of a number of known techniques, such as signature-based detection, data mining techniques and sandbox detection. Another type of IDS (or IPS) that may be used is a Host-based IDS (or HIDS). The HIDS can monitor inbound and outbound packets from a computer system on which it is installed (the host) to identify any suspicious activity. The HIDS can also monitor the configuration of the system to identify whether any suspicious changes are made to the system (such as unrecognised changes to critical system files) which might indicate that the computer system has been affected (or compromised) by a threat. The HIDS also typically includes anti-virus software which can detect malware using various techniques, such as signature-based detection, data mining techniques and sandbox detection, as is well known in the art. It will be appreciated that not all devices may be suited to having a HIDS installed on them. As an example, IoT devices may typically be less suited to having such software installed. However, the use of a NIDS within the network may help to identify threats affecting such devices, even if no HIDS software can be installed on them. It will be appreciated that different combinations of HIDS and NIDS may be used in different embodiments. For example, in some embodiments a NIDS might be used on its own, whilst in other embodiments HIDSs alone might be used. In yet further embodiments both HIDS and NIDS might be used in combination with HIDS being present on at least some of the computer systems in the network in addition to a NIDS.

The Security Information and Event Management (SIEM) system 216 acts to collect (or collate or aggregate) data from networks and networked devices which relates to the operation of those devices. The data collected by SIEM 216 can then be analysed in a way that correlates security events occurring throughout the network (rather than the analysis being performed individually for each device). The correlation of security events across different devices can result in meta-events being generated which indicate a particular pattern of events occurring in the network. The data collected by SIEM can come from the various computer systems 100 within the network. For example, information about network traffic, such as information about dropped, rejected or denied connection attempts, can be retrieved from the firewall 212 and routers 202a, 202b and 202c. As a further example, events generated by the HIDS and/or NIDS can be collected, providing information such as particular threats that have been detected, which computer systems 100 have encountered those threats (and when) and whether those computer systems 100 have been compromised by those threats. Other information may also be collected by the SIEM 216, such as the operating system and/or application logs for software running on the end-user computing devices 206, servers 208 and IoT devices 210. As will be appreciated, there is a vast array of different types of event that may be collected by SIEM 216 depending on the specific devices and applications running in the network 200. For example, information relating to login events (both failed and successful) may also be collected from the various computer systems 100 within the network 200, including, for example, login events from Active Directory, Syslog (Unix Hosts, Switches, Routers, VPN), RADIUS, TACACS, as well as any specific applications.

In some embodiments of the invention, as illustrated in FIG. 2, the computer network 200 may comprise a separate computer system 218 to protect the network in accordance with the method described below. This separate computer system may be referred to as a network protector 218. Of course, in other embodiments of the invention, this network protection functionality may be combined in the functions performed by one or more of the other computer systems present in the network, such as the SIEM 216. This protection functionality will now be described further in conjunction with FIG. 3.

FIG. 3 is a flowchart of a method 300 of protecting a computer network in accordance with embodiments of the present invention.

In general, at an operation 302, the method 300 receives security data for the computer network. The security data comprises threat event data. The threat event data represents threat events which have been detected within the portion of the computer network over a preceding period of time. The security data may be retrieved from (or provided by) the SIEM 216, where it has already been aggregated for the network. Alternatively, the method 300 may comprise retrieving the security data from the various computer systems 100 in the network 200 in a similar manner to that performed by the SIEM 216 as discussed above. However the security data is obtained by method 300, the original source of the threat event data is the data retrieved from the IDSs 214 within the network 200. Preferably, at least some or all of the IDSs 214 used in the network 200 comprise malware detection functionality which generate threat events whenever malware is detected in the network 200 (regardless of whether that malware has actually managed to compromise a computer system 100). However, even where malware detection functionality is not present, the IDSs 214 in the network 200 provide information about threats affecting computer systems 100 in the network. In addition to the threat event data, in some embodiments, the security data may include other information including, for example, the other types of information that may be collected by the SIEM 216 as discussed above (which may be collected from the SIEM 216 or separately from the individual computer systems 100). For example, the security data may include information regarding network traffic, such as proxy log, net flow data and packet data for each computer system 100. Of course, in some embodiments, this information may include more data than just network traffic, such as that provided by proxy logs and device logs. Having received the security information, the method 300 proceeds to an operation 304.

At operation 304, the method 300 extracts one or more features that are indicative of a computer system being compromised (i.e. that it has been or will be compromised) by a particular threat from the received security data. In some embodiments, the particular threat is a family of threats (or threat family) and the extracted features are indicative of a computer system being compromised by any threat belonging to that threat family. The features that are extracted are values which are derived from the security data that has been received and serve to reduce the dimensionality of the data. As an example, one feature that may be extracted is to determine, from the threat event data, a number of computer systems 100 that have been compromised by the particular threat (or threat family) at each of a plurality of preceding points in time. For example, the method 300 may determine at operation 304 the numbers of computer systems 100 which are indicated by the threat event data as having been compromised by that particular threat at the beginning of each day (for example, at midnight) for the preceding two weeks. Notably, the particular timeframe and frequency is exemplary and considerably longer or shorter periods with greater or lesser frequencies could be employed, including on a per second, per minute or per hour basis or the like.

Other features may also be extracted. These other features may be specific to the particular threat being considered and may be useful in forecasting the spread of that particular threat. As an example, it may be determined that a particular threat is more likely to compromise a computer system 100 if the computer system is running a particular piece of software (or a specific version of that software), such as a particular operating system. The received security information may therefore include configuration information for some or all of the computer systems 100 in the network 200 from which a feature indicating the number of computer systems 100 running that particular software that have yet to be compromised by the particular threat can be extracted. Of course it will be appreciated that there are a wide range of other features that can be used for this purpose and that the particular features that are extracted can vary according to the particular threat being considered.

All or some of these other features may be pre-determined by expert input. That is to say, the characteristics of the threat may be manually analysed to identify features from the security data that are indicative of vulnerability to the particular threat. As an example, information indicating the features that are to be determined by the method 300 may be stored in a centralised repository or database for each threat. Alternatively, the repository or database can be stored locally each network protector device. The method may then access that repository or database to determine which features should be extracted. In this way, newly identified features can be added to the repository or database for each threat to allow those features to be used by the method 300 in the future.

Alternatively or additionally, all or some of these other features to be extracted may be determined through the use of feature learning techniques (otherwise referred to as automated feature engineering, learning feature engineering or deep feature synthesis). Any suitable method of feature learning known in the art may be used as will be apparent to those skilled in the art including, for example, the use of clustering methods and/or principal component analysis and/or deep learning using recurrent neural networks. The use of such feature learning techniques provides the advantage that the method 300 adapts to the changing nature of the threats that face computer networks. In particular, the feature learning techniques may derive new, previously unidentified features, which are also indicative that a computer system will be compromised by the particular threat at a particular point in time. For example, the feature learning techniques could identify that a feature of the number of uncompromised computer systems running a particular piece of software is a good indicator of a computer system being compromised by the particular threat even where this was not already known.

Optionally, the method 300 performs an additional operation 306 as part of the operation 304 of feature extraction. At this additional operation 306, the method filters at least one, some, or all of the extracted features. This filtering can be performed using known machine learning or probabilistic methods such as principal component analysis or clustering methods. The filtering serves to de-emphasise (or reduce) or filter out (or remove) noise from the features. This can help prevent any subsequent machine learning steps in the method 300 from overfitting to the features extracted from the received security data. The filtering may be particularly beneficial when used in conjunction with features that have been learnt through feature learning. This is because machine learning based on such features can be particularly prone to suffering from overfitting. Therefore, filtering at operation 306 can improve the results of machine learning carried out in subsequent operations. The features which are filtered at step 306 are referred to herein as filtered features.

Having extracted the features at operation 304 and, optionally, having filtered one or more of those features at operation 306, the method proceeds to an operation 308.

At an operation 308, the method 300 generates a forecast of a number of computer systems in the computer network which will be compromised by the particular threat. The forecast is generated based on the one or more extracted features. As will be appreciated, there are number of different techniques which may be used to produce the forecast.

In some embodiments, time series methods, such as Autoregressive Moving Average Model (ARIMA), ARIMA with an explanatory variable (ARIMAX), Vector Autoregression (VAR) and Autoregressive Neural Networks (NNAR), may be used. Of course, such time series methods require the features that are extracted from the security data to include a feature representing the numbers of computer systems that have been compromised by the threat at each of a plurality of preceding points in time. However, some time series methods, such as ARIMAX, may also make use of other features (for example to provide an explanatory variable used by the model).

In other embodiments, machine learning methods, such as regression or classification methods, including gradient boosting or random forest, or deep learning methods or recurrent neural networks may be used. Such machine learning methods can make use of a wide range of features. The features that are used can include features representing the numbers of computer systems that have been compromised by the threat at each of a plurality of preceding points in time. However, this need not be the case. As will be appreciated, the machine learning methods can learn based on features which reflect the symptoms of computer systems being compromised by a particular threat. Therefore, they are able to produce a forecast without being provided with a feature which explicitly represents the numbers of computer systems that have been compromised by the threat in the past.

Having generated the forecast at operation 308, the method 300 proceeds to an operation 310.

At operation 310, the method 300 determines whether action should be taken to mitigate the particular threat based on the number of computer systems that are forecast to be compromised by that threat. Although, ideally, action would be taken against all threats, it will be appreciated that, for real-world networks, there is a limited amount of resource available and so this may not be possible, feasible, appropriate or preferable. Accordingly, the method 300 enables actions to be taken against threats (such as malware) based on a forecast of the magnitude of that threat (i.e. the number of computer systems that it is likely to compromise). In one embodiment, a predetermined threshold (or baseline) may be set. In this embodiment, the method 300 may determine, at operation 310, whether the number of computer systems that are forecast to be compromised by the threat will exceed the predetermined threshold. In some embodiments, the predetermined threshold is a universal threshold for any threat to the network. That is to say, the threshold is the same regardless of a particular threat being considered. In other embodiments, the predetermined threshold may be threat specific. In such embodiments, the predetermined threshold for the particular threat being considered may be looked up, for example, from a database. In such embodiments, the predetermined threshold could be set proportionately to the potential damage caused by the threat—accordingly, threats which may have a more severe impact on compromised computer systems 100 (or which are more likely to affect systems where the impact to an organisation may be more severe) may be provided with a lower pre-determined threshold such that action to mitigate such threats occurs at an earlier stage and vice-versa. Of course, it will be appreciated that there are many other ways in which it can be determined whether or not predetermined actions should be taken to mitigate the threat based on the forecast number of computer systems that are likely to be compromised by the threat, any of which may be used with embodiments of the invention. For example, where the method is operated against multiple different threats, the threat (or a predetermined proportion of the threats) with the highest forecast could be selected and predetermined actions taken to mitigate that threat (or those threats), with no action being taken to mitigate other threats with lower forecasts. In other embodiments, the forecasts may be used to apportion the resources available for carrying out mitigating actions amongst a number of different threats being considered. In such embodiments, the resources allocated for mitigating the threat may, for example, be in accordance with the ratio of the number of computer systems that are forecast to be compromised by that threat compared to the number of computer systems that are forecast to be compromised by other threats. In such embodiments, determining whether action should be taken to mitigate the particular threat may be based on whether sufficient resources have been allocated for mitigating that threat for any of the predetermined actions to be carried out. In any case, regardless which of the many possible mechanisms is used to determine whether action should be taken to mitigate the threat based on the number of computer systems that are forecast to be compromised by that threat, if, at operation 310, the method 300 determines that action should be taken, the method proceeds to an operation 312; otherwise, the method 300 ends.

At operation 312, the method 300 causes one or more predetermined actions to be taken to mitigate the particular threat. In some embodiments, the one or more predetermined actions includes raising an alarm, such as by sending out a warning email or SMS message to a network administrator, or otherwise drawing their attention to that particular threat. In some embodiments, the one or more predetermined actions includes carrying out enhanced automatic scanning of computer systems in the network. In some embodiments, the one or more predetermined actions includes segregating one or some or all of the compromised computer systems in the network from one or some or all of the other computer systems. This segregation can be achieved by, for example, air-gapping part of the network, re-routing part of the network or temporarily blocking the communications of the compromised computer systems. It will be appreciated that these are merely intended to provide examples of the types of predetermined actions that could be taken to mitigate the threat and that any predetermined action which helps to mitigate a threat may be used.

In some embodiments the actions that are to be taken by operation 312 may be determined as part of operation 310. That is to say, operation 310 may select which of a set of predetermined actions should be carried out by operation 312. As an example, in some embodiments, operation 310 may compare the forecast of the number of computer systems which will be compromised by the threat to multiple different predetermined thresholds. In such embodiments, the operation 310 may select a different set of predetermined actions to be taken by operation 312 based on which of the multiple different predetermined thresholds the forecast exceeds. Similarly, in other embodiments where resources for carrying out actions for mitigating the threat are apportioned based on the forecast, the operation 310 may select a set of predetermined actions based on the amount of resources that have been allocated (for example, where insufficient resources are available for carrying out all available predetermined actions, the operation 310 may reduce the set of predetermined actions that are to be carried out such that there are sufficient resources available to carry out the reduced set of predetermined actions).

At operation 312, the method 300 causes one or more predetermined actions to be taken to mitigate the particular threat. In so doing, the threat may be reduced, eliminated or mitigated for the future time period.

As illustrated in FIG. 3, after completing operation 312 the method 300 ends. Of course, it will be appreciated that the method 300 may be run periodically and that the frequency at which iterations of method 300 are run may vary. In this way, the method 300 can provide continuous forecasting of the numbers of computer systems which will be compromised by a particular threat to allow appropriate mitigating actions to be taken before the particular threat causes a more significant impact to the network 200.

The forecasts may be presented within a user interface to provide network operators with visualisations regarding the forecast health of the network. For example, the total forecast numbers of each threat and/or threat family may be presented to network operators within a user interface. Visual indicators, such as flashing backgrounds, may be used in the user interface to draw the attention of network operators to particular threats and/or threat families based on the forecasts for each threat and/or threat family.

Although the method 300 has been described above as producing a forecast for a particular threat, it will be appreciated that in some embodiments, the method 300 may produce respective forecasts for multiple different threats. Accordingly, actions to mitigate the different threats may be taken based on the individual forecasts for each threat. This is akin to running multiple instances of the method 300, one for each of the threats. In some such embodiments, the method may combine the forecasts for all or a subset of the threats, for example, to generate a forecast for a particular family (or class) of threats. In these embodiments, operation 310 may decide whether predetermined actions should be taken based on the combined forecast. This can lead to more efficient mitigating actions being taken since the mitigating actions for dealing with each of a particular family of threats can be similar. Therefore, by taking mitigating actions that would deal with one of threats in the family, computer systems 100 may also be protected from other threats in that family. Therefore, even if the forecast for each of the threats in the family is not sufficiently high for them to individually cause mitigating action to be taken, it may be worth doing so if the combined forecast for threats in the family is sufficiently high. Of course, as described above, the features that are extracted can, in some embodiments, be indicative of a computer system being compromised by any threat in a particular family of threats, such that the forecast that is generated will itself represent the number of computer systems that will have been compromised by any threat in that family of threats without needing to generate (and then combine) separate forecasts for each threat in the family.

Embodiments of the present invention can help to protect a computer network by forecasting numbers of computer systems that are likely to be compromised by particular threats and enabling remedial and/or mitigating actions to be taken appropriately. In this manner, even when a computer network is simultaneously faced with a number of different threats, resources can be allocated to mitigate those threats based on the likely magnitude that those threats will present to the network. This can assist any anti-malware operations that may be performed by a network operator by providing the capability of foreseeing a future malware outbreak and enabling the outbreak to be controlled before it even happens. Additionally, the present invention may help to identify whether current efforts to combat a particular threat are being effective.

Insofar as embodiments of the invention described are implementable, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods is envisaged as an aspect of the present invention. The computer program may be embodied as source code or undergo compilation for implementation on a processing device, apparatus or system or may be embodied as object code, for example.

Suitably, the computer program is stored on a carrier medium in machine or device readable form, for example in solid-state memory, magnetic memory such as disk or tape, optically or magneto-optically readable memory such as compact disk or digital versatile disk etc., and the processing device utilises the program or a part thereof to configure it for operation. The computer program may be supplied from a remote source embodied in a communications medium such as an electronic signal, radio frequency carrier wave or optical carrier wave. Such carrier media are also envisaged as aspects of the present invention.

It will be understood by those skilled in the art that, although the present invention has been described in relation to the above described example embodiments, the invention is not limited thereto and that there are many possible variations and modifications which fall within the scope of the invention.

The scope of the present invention includes any novel features or combination of features disclosed herein. The applicant hereby gives notice that new claims may be formulated to such features or combination of features during prosecution of this application or of any such further applications derived therefrom. In particular, with reference to the appended claims, features from dependent claims may be combined with those of the independent claims and features from respective independent claims may be combined in any appropriate manner and not merely in the specific combinations enumerated in the claims.

1. A computer implemented method of protecting a network of computer systems, the method comprising:
receiving security data for the network, the security data comprising threat event data for threat events detected within the network over a period of time;
extracting, from the received security data, one or more features indicative of a computer system being compromised by a particular threat;
generating a forecast of a number of computer systems in the network compromised by the particular threat at a future point in time based on the one or more features;
determining whether action should be taken to mitigate the particular threat based on the forecast; and
in response to determining that action should be taken, causing one or more predetermined actions to be taken to mitigate the particular threat.

2. The method of claim 1, wherein the particular threat is a threat family.

3. The method of claim 1, wherein the security data further comprises data relating to network traffic within the computer network.

4. The method of claim 1, wherein the forecast is generated using a machine learning technique based on the one or more features.

5. The method of claim 1, wherein extracting the one or more features comprises determining a respective number of computer systems that have been affected by the particular threat at each of a plurality of points in time in the period of time.

6. The method of claim 5, wherein the forecast is generated using a time series analysis based on the respective numbers of computer systems that have been affected by the one or more particular threats at each of the plurality of points in time.

7. The method of claim 1, wherein the method further comprises discovering at least one of the one or more features to be extracted through feature learning.

8. The method of claim 1, wherein the method further comprises filtering at least one of the one or more extracted features to produce one or more filtered features, wherein the features upon which the forecast is generated comprise the one or more filtered features.

9. The method of claim 1, wherein the one or more predetermined actions comprise one or more of:
raising an alarm;
carrying out enhanced automatic scanning of computer systems in the network;
carrying out enhanced automatic patching of computer systems in the network; and
segregating one or more or all of the compromised computer systems in network.

10. The method of claim 1, wherein the one or more predetermined actions are caused to be taken in response to the forecast number of computers exceeding a predetermined threshold.

11. The method of claim 1, wherein the method further comprises:
extracting, from the received security data, one or more features indicative of a computer system being compromised by an additional threat;
generating a forecast of a number of computer systems in the computer network compromised by the additional threat at a future point in time based on the one or more features indicative of a computer system being compromised by the additional threat;
determining whether action should be taken to mitigate the additional threat based on the forecast of the number of computer systems compromised by the additional threat at the future point in time; and
in response to determining that action should be taken to mitigate the additional threat, causing one or more predetermined actions to be taken to mitigate the additional threat.

12. A computer system comprising a processor and a memory storing computer program code which, when executed by the processor cause the processor to perform a method according to claim 1.

13. A computer program which, when executed by one or more processors, is arranged to cause the processor to carry out a method according to claim 1.
